(19) United States
(12) Patent Application Publication
(10) Pub. No.: US 2006/0148513 A1
(43) Pub. Date: Jul. 6, 2006

(54) Electronic device with flexible shaft

(75) Inventors: Yuan-Ming Chan, Changhua County (TW); Pei-Chun Yang, Nantou County (TW); Kai-Hung Wang, Taipei City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/325,862

(22) Filed: Jan. 4, 2006

(30) Foreign Application Priority Data
Jan. 5, 2005 (TW) TW94100237

(51) Int. Cl. H04M 1/00

(52) U.S. Cl. 455/550.1

(57) ABSTRACT

An electronic device with a flexible shaft. The electronic device includes a first body, a second body, a fixed member, and a flexible shaft. The first body includes a first groove, and the second body includes a second groove. The fixed member is disposed on the first and second grooves, and is moveable between a first position and a second position. The flexible shaft connects the first and second bodies. When the fixed member is in the first position, the flexible shaft is fully received in the first and second bodies. When the fixed member is in the second position, the flexible shaft is partially exposed between the first and second bodies so that the second body may rotate with respect to the first body by the flexible shaft.

### BACKGROUND

The invention relates to an electronic device, and in particular, to an electronic device with a flexible shaft.

Generally, mobile phones may be divided into the non-folding bar type and the folding clamshell type. Currently, there is no mobile phone that combines the bar type and the clamshell type.

### SUMMARY

In view of this, electronic devices are provided. An exemplary embodiment of an electronic device comprises a first body, a second body, a fixed member, and a flexible shaft. The first body comprises a first groove, and the second body comprises a second groove. The fixed member is disposed on the first groove and the second groove to be moveable between a first position and a second position. The flexible shaft connects the first body and the second body. When the fixed member is in the first position, the flexible shaft is fully received in the first body and the second body. When the fixed member is in the second position, the flexible shaft is partially exposed between the first body and the second body so that the second body rotates with respect to the first body by the flexible shaft.

The fixed member further comprises a first protrusion and a second protrusion. The first body comprises a first hole and a second hole on the first groove. The second body comprises a third hole on the second groove. When the fixed member is in the first position, the first and second protrusions are received in the third and first holes respectively. When the fixed member is in the second position, the first and second protrusions are received in the first and second holes respectively.

The flexible shaft comprises a plurality of connecting members connecting with each other, and a blocking member combined with the connecting member. Each connecting member comprises a receiving portion, a fixed portion, and an intermediate portion connecting the fixed portion and the receiving portion. The receiving portion comprises a plurality of notches to fix the fixed member in different positions. The depth of the receiving portion is substantially equal to the length of the intermediate portion. The fixed portion of one of the connecting members is located in the receiving portion of the adjacent connecting member. The fixed potion comprises rubber, and is maintained in the receiving portion by the blocking member abutting the intermediate portion.

Additionally, the flexible shaft may be a flexible tube. The second body may comprise a digital camera. The electronic device may be a mobile phone.

### DESCRIPTION OF THE DRAWINGS

The invention can be more fully understood by reading the subsequent detailed description and examples with references made to the accompanying drawings, wherein:

FIGS. 1a-1b are schematic views of an embodiment of an electronic device, wherein a fixed member is located in a first position;

FIG. 2a-4c are other schematic views of the electronic device in FIG. 1a, wherein the fixed member is located in a second position; and

FIG. 5 is a schematic view of a flexible shaft in FIG. 1a.

### DETAILED DESCRIPTION

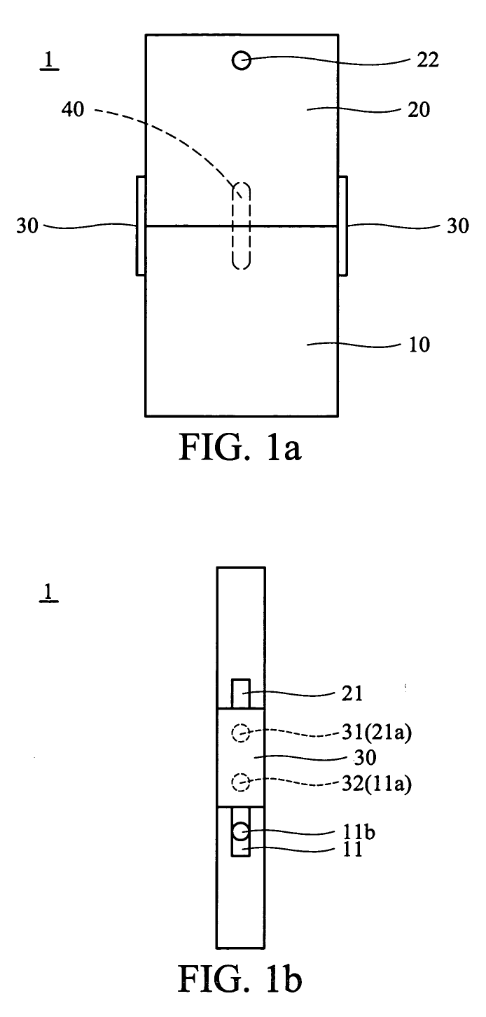

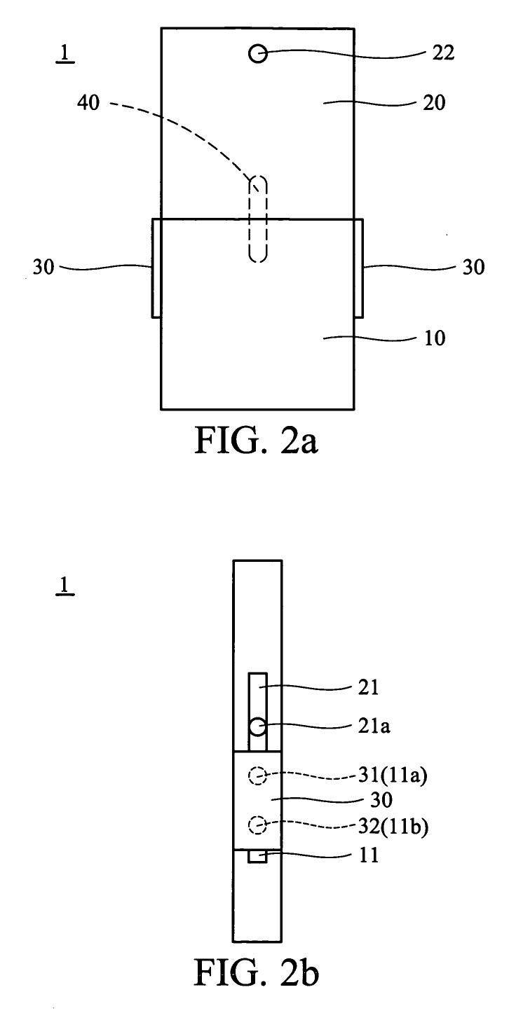

FIGS. 1a-4c depict an embodiment of an electronic device 1 comprising a first body 10, a second body 20, two fixed members 30, and a flexible shaft 40.

In FIG. 1a, the first body 10 is located at the lower portion of the electronic device 1, and comprises a first groove 11 on both sides. The first body 10 further comprises a first hole 11a and a second hole 11b on each first groove 11. The second body 20 is located at the upper portion of the electronic device 1, and comprises a second groove 21 on both sides. The second body 20 further comprises a third hole 21a on each second groove 21.

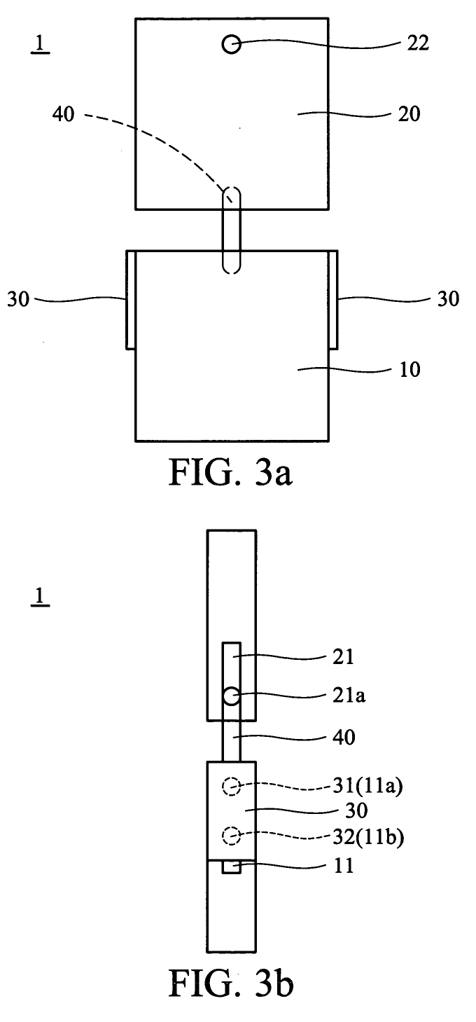

Each fixed member 30 is disposed on the first groove 11 and the second groove 21 on the sides of the electronic device 1 to be moveable between a first position (as shown in FIG. 1b) and a second position (as shown in FIG. 3b). Each fixed member 30 comprises a first protrusion 31 and a second protrusion 32. In this embodiment, the electronic device 1 comprises a fixed member 30 on both sides. However, it is contemplated that the electronic device 1 may also comprise only a single fixed member on one side.

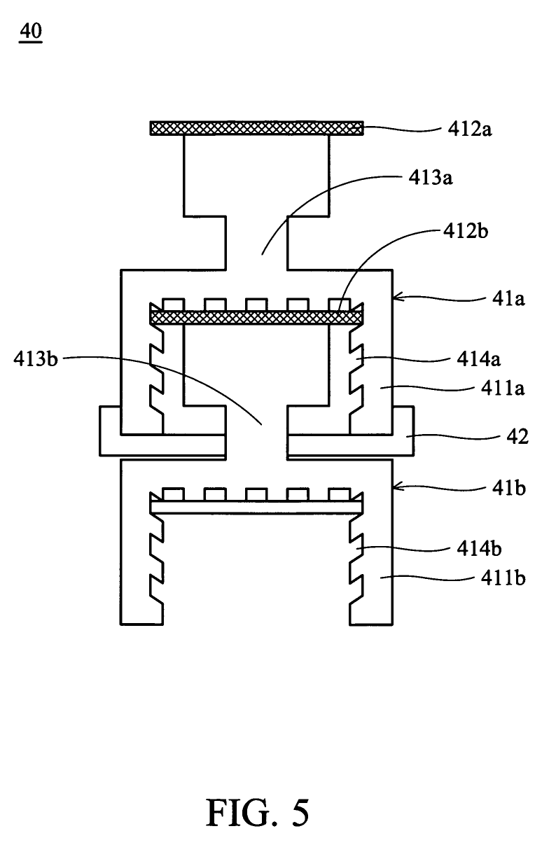

The flexible shaft 40 is located in the first body 10 and the second body 20 to connect the first body 10 and the second body 20. Referring to FIG. 5, the flexible shaft 40 comprises a plurality of connecting members 41a and 41b and a plurality of blocking members 42. Note that only two connecting members and one blocking member are shown in FIG. 5. The connecting members 41a and 41b are connected to each other. Each connecting member 41a and 41b comprises a receiving portion 411a and 411b, a fixed portion 412a and 412b, and an intermediate portion 413a and 413b connected to the fixed portion 411a and 411b and the receiving portion 412a and 412b respectively. As shown in FIG. 5, the fixed portion 412b of the connecting members 41b is located in the receiving portion 411a of the adjacent connecting member 41a. The blocking member 42 is combined with the connecting member 41a. The fixed potion 412b is maintained in the receiving portion 411a by the blocking member 42 abutting the intermediate portion 413b. Note that the depth of the receiving portion 411a and 411b is substantially equal to the length of the intermediate portion 413a and 413b. Each receiving portion 413a and 413b comprises a plurality of notches 414a and 414b for fixing the fixed member in various positions. Each fixed member 412a and 412b may be made of rubber.

Alternatively, while the flexible shaft 40 comprises a plurality of members in this embodiment, it is not limited to this, and may be a flexible tube.

Note that the electronic device 1 may be a mobile phone, and the second body 20 may comprise a digital camera 22.

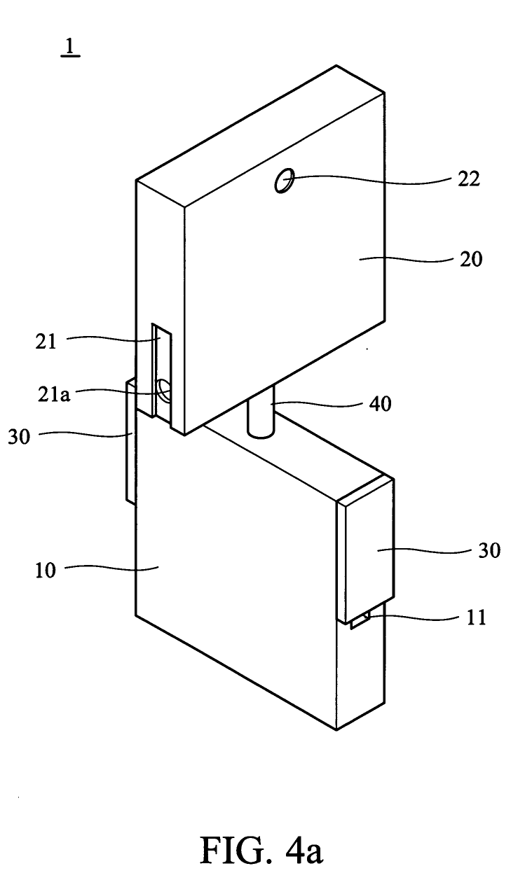

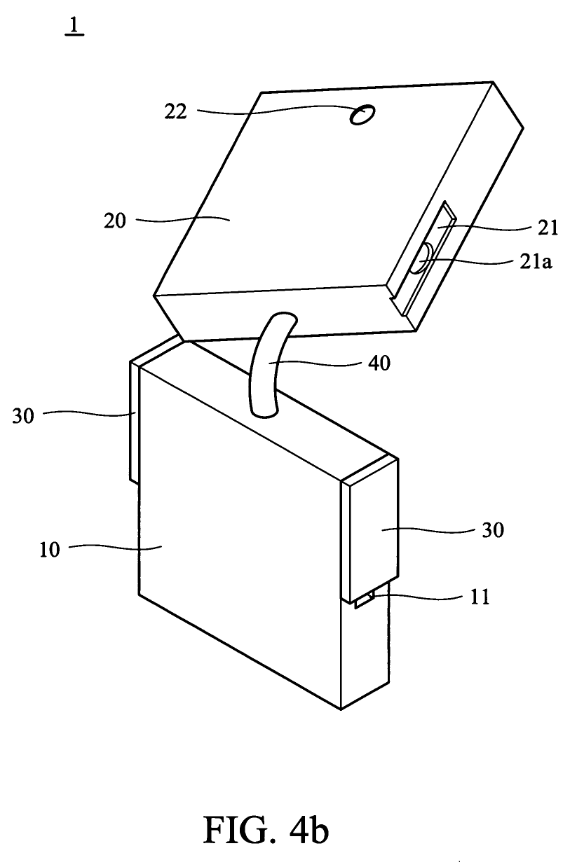

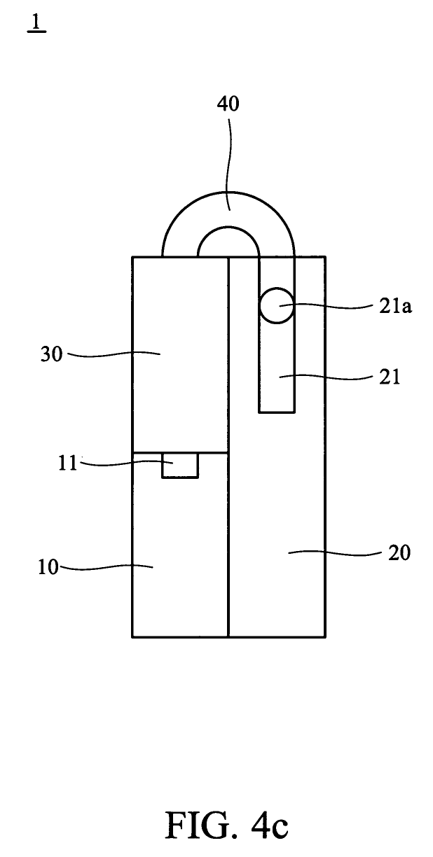

When the electronic device 1 is used as a bar type, the fixed member 30 is in the first position. At the same time, the first and second protrusions 31 and 32 are received in the third and first holes 21a and 11a respectively while the flexible shaft 40 is fully received in the first body 10 and the second body 20, as shown in FIG. 1b. When the electronic device 1 is used as a clamshell type, the fixed member 30 is in the second position. At the same time, the first and second protrusions 31 and 32 are received in the first and second holes 11a and 11b respectively while the flexible shaft 40 is partially exposed between the first body 10 and the second body 20, as shown in FIG. 3a. Thus, the second body 20 can rotate or fold with respect to the first body 10 by the flexible shaft 40, as shown in FIGS. 4a-4c.

As previously described, the mobile phone may be both a bar type and a clamshell type, thus satisfying more users. Furthermore, since the second body can rotate in any direction, the digital camera thereon may be operated at any angle.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a first body comprising a first groove;
a second body comprising a second groove;
a fixed member disposed on the first groove and the second groove, and is moveable between a first position and a second position; and
a flexible shaft connecting the first body and the second body, wherein the flexible shaft is fully received in the first body and the second body when the fixed member is in the first position, and the flexible shaft is partially exposed between the first body and the second body so that the second body rotates with respect to the first body by the flexible shaft when the fixed member is in the second position.

2. The electronic device as claimed in claim 1, wherein the fixed member comprises a first protrusion and a second protrusion, the first body comprises a first hole and a second hole on the first groove, the second body comprises a third hole on the second groove, the first protrusion and the second protrusion are received in the third hole and the first hole respectively when the fixed member is in the first position, and the first protrusion and the second protrusion are received in the first hole and the second hole respectively when the fixed member is in the second position.

3. The electronic device as claimed in claim 1, wherein the flexible shaft comprises a plurality of connecting members connecting with each other, each connecting member comprises a receiving portion and a fixed portion, and the fixed portion of one of the connecting members is located in the receiving portion of the adjacent connecting member.

4. The electronic device as claimed in claim 3, wherein the flexible shaft further comprises a blocking member combined with the connecting member, the connecting member further comprises an intermediate portion connecting the fixed portion and the receiving portion, and the fixed potion is maintained in the receiving portion by the blocking member abutting the intermediate portion.

5. The electronic device as claimed in claim 4, wherein the depth of the receiving portion is substantially equal to the length of the intermediate portion.

6. The electronic device as claimed in claim 3, wherein the receiving portion comprises a plurality of notches to fix the fixed member to different positions.

7. The electronic device as claimed in claim 3, wherein the fixed portion comprises rubber.

8. The electronic device as claimed in claim 1, wherein the flexible shaft is a flexible tube.

9. The electronic device as claimed in claim 1, wherein the second body comprises a digital camera.

10. The electronic device as claimed in claim 1, wherein the electronic device is a mobile phone.
